(19) United States
(12) Patent Application Publication
(10) Pub. No.: US 2017/0242876 A1
(43) Pub. Date: Aug. 24, 2017

(54) Maintaining Database Referential Integrity Using Different Primary and Foreign Key Values

(71) Applicant: CA, Inc., New York, NY (US)

(72) Inventor: Philippe Dubost, Praha 7 (CZ)

(21) Appl. No.: 15/049,263

(22) Filed: Feb. 22, 2016

(51) Int. Cl. G06F 17/30

(52) U.S. Cl. CPC G06F 17/30292; G06F 17/30595; G06F 17/30321

(57) ABSTRACT

A computing device managing a database receives a database command comprising first and second identifiers identifying first and second datasets, respectively, in the database. The database command further comprises a key translation indicator identifying a key value translation function. Responsive to receiving the database command, the computing device generates a translated key value from a primary key value of a first record in the first dataset using the key value translation function, and generates a second record in the second dataset. The second record comprises the translated key value. Subsequently, the computing device selects the first and second records from the first and second datasets, respectively. To select the first and second records, the computing device applies the key value translation function to one of the primary or translated key value to determine the other of the primary or translated key value.

### BACKGROUND

Databases are a common way for computing devices to store information. Relational databases, in particular, store such information in the records of separate related datasets. Thus, for example, a database that tracks dogs and their owners may have a first dataset representing the owners, and a second dataset representing the dogs that belong to those owners. A relational database associates the owners in the first dataset with the dogs in the second dataset through the use of primary and foreign keys. Traditionally, when the primary key value of a record in the first dataset matches the foreign key value of a record in the second dataset, those two records are considered to be related or associated with each other.

A primary key is a field (or set of fields) that uniquely identifies a single record in a dataset. For example, a social security number or employee ID is generally a good choice for a primary key, because those values tend to be inherently unique. A person's first and last name is generally not a good choice for a primary key field because it is possible, for example, for two people named “John Smith” to each need to be unambiguously represented in the database. For example, if the database described above had two dog owners named “John Smith,” and a dog was related in the database to “John Smith” by using “John Smith” as the value of the foreign key in that dog's record, it would be ambiguous as to which “John Smith” record the dog's record is related to. However, if the dog's record used a unique owner ID as a foreign key value matching one (and only one) record in the owner dataset, there would be no ambiguity as to which owner owns the dog.

An important concept in relational databases is the notion of referential integrity. Traditionally, referential integrity exists between two datasets of a relational database when the foreign key value of every record in one of the datasets is either null, or matches a primary key value in the other of the datasets. Relational databases traditionally enforce referential integrity by correcting the dataset with foreign keys (i.e., the child dataset) when records are deleted from the dataset with corresponding primary keys (i.e., the parent dataset). In other words, if John Smith died, upon deletion of John Smith's owner record, the foreign key values of all dog records assigned to John Smith would be set to a null value, set to another owner's primary key value, or those dog records would also be deleted, for example, so that all dog records make valid (or no) reference to a record in the parent table.

Many databases store data that is very sensitive in nature, such as credit card transactions and medical records. According to traditional relational databases, if a malfeasant is able to save the contents of all of the datasets of a database to a storage system under their control, that malfeasant would easily be able to recognize which records of one dataset are related to which records of another dataset because it is known that traditional relational databases reflect the relationship between records using matching primary and foreign key values, as discussed above. Thus, a malfeasant would be able to discern which patients have which illnesses, for example, or which buyers purchased which items and for how much. Due to the highly sensitive nature of the data that may be stored in modern databases, maintaining security in relational databases is important.

### SUMMARY

Embodiments of the present disclosure hinder the ability of a malfeasant to determine the relationship between datasets of a database by obfuscating the relationship between primary and foreign keys therein. In particular, embodiments of the present disclosure maintain referential integrity between two datasets without requiring that the foreign key value of a record in one dataset be the same as the primary key value of a record in the other. Rather, a key value translation function is used to translate between primary and foreign key values, such that the relationship between records of the datasets is not clear to an ordinary observer.

In particular, various embodiments of the present disclosure include computer-implemented methods, systems, apparatus, and non-transitory computer readable mediums storing computer program products for maintaining database referential integrity using different primary and foreign key values. In an embodiment, a computer-implemented method comprises receiving, by a computing device managing a database, a database command comprising first and second identifiers identifying first and second datasets, respectively, in the database. The database command further comprises a key translation indicator identifying a key value translation function. Responsive to receiving the database command, the method further comprises generating a translated key value from a primary key value of a first record in the first dataset using the key value translation function, and generating a second record in the second dataset. The second record comprises the translated key value. The method further comprises selecting the first and second records from the first and second datasets, respectively. The selecting comprises applying the key value translation function to one of the primary or translated key value to determine the other of the primary or translated key value.

In another embodiment, a computing device comprises interface circuitry and processing circuitry. The interface circuitry is configured to exchange signals with a database managed by the computing device and a user interface. The processing circuitry is communicatively coupled to the interface circuitry and is configured to identify first and second datasets of the database by first and second identifiers, respectively. The processing circuitry is further configured to generate a second record in the second dataset via the interface circuitry. The second record comprises a translated key value generated from a primary key value of a first record in the first dataset according to a key value translation function. The processing circuitry is further configured to select the first and second records from the first and second datasets, respectively. To select the first and second records the processing circuitry is configured to apply the key value translation function to one of the primary or translated key value to determine the other of the primary or translated key value.

In yet another embodiment, a non-transitory computer readable medium stores a computer program product for controlling a programmable computing device managing a database. The computer program product comprises software instructions that are executable to cause the programmable computing device to receive a database command comprising first and second identifiers identifying first and second datasets, respectively, in the database, and a key translation indicator identifying a key value translation function. Responsive to receiving the database command, the software instructions further cause the programmable computing device to generate a translated key value from a primary key value of a first record in the first dataset using the key value translation function, and generate a second record in the second dataset. The second record comprises the translated key value. The software instructions further cause the programmable computing device to select the first and second records from the first and second datasets, respectively. The selecting comprises applying the key value translation function to one of the primary or translated key value to determine the other of the primary or translated key value.

The embodiments of the present disclosure are not limited to the above contexts or examples, but may include other features and advantages, such as those described in the following detailed description.

### BRIEF DESCRIPTION OF THE DRAWINGS

Aspects of the present disclosure are illustrated by way of example and are not limited by the accompanying figures with like references indicating like elements. In general, the use of a reference numeral should be regarded as referring to the depicted subject matter generally, whereas discussion of a specific instance of an illustrated element will append a letter designation thereto (e.g., discussion of a dataset 210, generally, as opposed to discussion of particular instances of datasets 210a, 210b, 210c).

FIG. 1 is a block diagram illustrating an example network environment supporting devices according to one or more embodiments of the present disclosure.

FIG. 2 is a block diagram illustrating a database according to one or more embodiments of the present disclosure.

FIG. 3 is a block diagram illustrating a translation function pool according to one or more embodiments of the present disclosure.

FIGS. 4A-E illustrate examples of datasets of a database according to one or more embodiments of the present disclosure.

FIG. 5 is a flow diagram illustrating an example computer-implemented method according to one or more embodiments of the present disclosure.

FIG. 6 is a block diagram illustrating example hardware configured according to one or more embodiments of the present disclosure.

### DETAILED DESCRIPTION

As will be appreciated by one skilled in the art, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented entirely as hardware, entirely as software (including firmware, resident software, micro-code, etc.), or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

To the extent that “one of” a conjunctive list of items (e.g., “one of A and B”) is discussed, the present disclosure refers to one (but not both) of the items in the list (e.g., an A or a B, but not both A and B). Such a phrase does not refer to one of each of the list items (e.g., one A and one B), nor does such a phrase refer to only one of a single item in the list (e.g., only one A, or only one B). Similarly, to the extent that “at least one of” a conjunctive list of items is discussed (and similarly for “one or more of” such a list), the present disclosure refers to any item in the list or any combination of the items in the list (e.g., an A only, a B only, or both an A and a B). Such a phrase does not refer to one or more of each of the items in the list (e.g., one or more of A, and one or more of B).

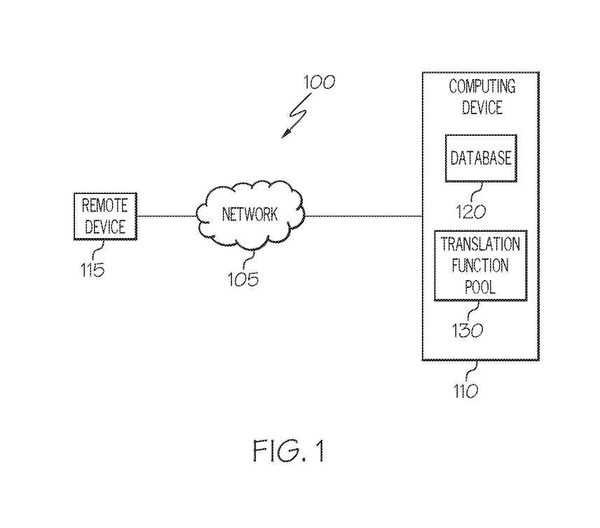

In general, embodiments of the present disclosure relate to a computing device that manages a database. FIG. 1 illustrates an example network environment 100 in which just such a computing device 110 may operate. In the example of FIG. 1, the network environment 100 includes the computing device 110, a remote device 115, and a network 105 interconnecting the devices 110, 115.

The network 105 is any network capable of exchanging communication signals with the computing device 110 and remote device 115. Examples of the network 105 include (but are not limited to) one or more of: the Internet; one or more local area networks; one or more wireless networks; one or more cellular networks; one or more Internet Protocol-based networks; one or more Ethernet networks; one or more optical networks; and one or more circuit switched networks. The network 105 may comprise any number of networking devices such as routers, gateways, switches, hubs, firewalls, and the like (not shown) supporting the exchange of such communication signals.

The remote device 115 is communicatively connected to, and capable of exchanging signals with, the network 105. Examples of the remote device 115 include a personal computer, a laptop computer, a desktop computer, a workstation, a smartphone, a tablet computer, a wearable computer, a server, a server cluster, a smart appliance, network attached storage, and a storage area network.

The computing device 110 is also communicatively connected to, and capable of exchanging signals with, the network 105. The computing device 110 comprises a database 120 and a translation function pool 130, which will be discussed in greater detail below. Examples of the computing device 110 include a personal computer, a laptop computer, a desktop computer, a workstation, a smartphone, a tablet computer, a wearable computer, a server, a server cluster, a smart appliance, network attached storage, and a storage area network.

Although FIG. 1 depicts a computing device 110 that comprises a database 120 and translation function pool 130, according to other embodiments of the present disclosure, the database 120, the translation function pool 130, or both the database 120 and the translation function pool 130 are comprised within the remote device 115, and accessed by the computing device 110 via the network 105. Further, although FIG. 1 depicts an example network environment 100 that comprises a network 105 and a remote device 115, other embodiments include standalone configurations of the computing device 110 (i.e., without the network 105 and remote device 115).

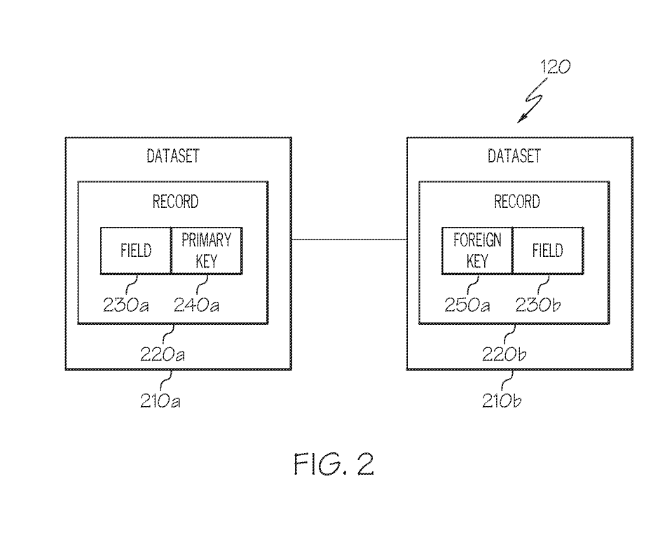

FIG. 2 illustrates an example database 120, according to embodiments of the present disclosure. Example database 120 includes two datasets 210a, 210b. Each dataset 210a, 210b comprises a record 220a, 220b, respectively. The record 220a comprises a field 230a and a primary key 240a. The record 220b comprises a field 230b and a foreign key 250a. The two datasets 210a, 210b are associated with each other by the values stored in the primary key 240a and foreign key 250a of the respective records 220a, 220b. The value of one of these two keys 240a, 250a may be determined by applying a key value translation function to the other of the two keys 240a, 250a. Accordingly, the records 220a, 220b are associated with each other by having a primary key 240a and a foreign key 250a, respectively, which correspond according to the key value translation function. According to this example, the key value translation function is one of a plurality of predefined key value translation functions stored in the translation function pool 130.

Although FIG. 2 illustrates two datasets 210a, 210b, other embodiments of the database 120 include more than two datasets 210. Further, although each dataset 210a, 210b is depicted in FIG. 2 as having one record 220a, 220b respectively, other embodiments of the database 120 have a dataset 210 that comprises a plurality of records 220. Several of these embodiments will be discussed in further detail below.

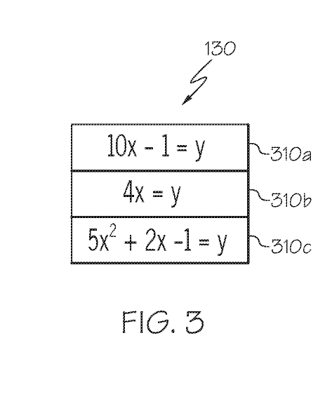

An example translation function pool 130 is illustrated in FIG. 3. The translation function pool 130 of FIG. 3 comprises three key value translation functions 310a, 310b, 310c. Each of the key value translations 310a, 310b, 310c specify a translation scheme between a primary key 240 value (represented by the variable x) and a foreign key 250 value (represented by the variable y). For example, the key value translation function 310a multiplies a primary key 240 value by ten, then subtracts one, to determine a corresponding foreign key 250 value.

Although FIG. 3 illustrates key value translation functions 310a-c that map a primary key 240a to a foreign key 250a value, the inverse of the functions 310a-c depicted in FIG. 3 map the foreign key 250a back to the primary key 240a. Thus, to determine the primary key 240a value from the foreign key 250a value according to key value translation function 310a, one is added to the foreign key 250a value, and the result is divided by ten. Accordingly, despite the functions 310a-c being depicted in FIG. 3 in the form f(x)=y for purposes of explanation, a key value translation function 310 allows for any one of the primary key 240a and the foreign key 250a values to be determined from the other, either directly or by extrapolation (e.g., by applying logical mathematical properties).

Further, although the key value translation functions 310a-c are depicted in FIG. 3 as mathematical expressions, a key value translation function 310 may include other ways of translating between primary key 240 and foreign key 250 values. Other examples of key value translation functions 310 include, but are not limited to, applying a cipher (e.g., a substitution cipher), bit-shifting, converting, compressing/decompressing, encrypting/decrypting, and/or encoding/decoding between the values.

The particular key value translation function 310 to be used to maintain referential integrity between datasets 210 of the database 120 may be identified in various ways, depending on the embodiment. For example, in one embodiment, the key value translation functions 310a-c in the translation function pool 130 are predefined, and the particular key value translation function 310 to be used to maintain referential integrity between datasets 210a-b of the database 120 is selected by the computing device 110 at random.

In another embodiment, a key value translation function 310 is user-specified and received in a database command that identifies the datasets 210a-b to be related. The received key value translation function 310 is then stored in the translation function pool 130 for future use.

In another embodiment, the key value translation function 310 is generated by computing device 110 and stored in the translation function pool 130 for future use in response to a database command. For example, the computing device 110 may randomly generate coefficients to plug into a base polynomial formula. As one simple example, the computing device may use a base polynomial formula of Ax²+Bx−C=y, wherein x is the value of the primary key 240, y is the value of the foreign key 250, and the values of A, B, and C are randomly-generated coefficients that the computing device 110 generates in response to the database command. In such an example, if the computing device 110 generates values for A, B, and C of 5, 2, and 1, respectively, the resulting key value translation function 310c would be 5x²+2x−1=y. The generated key value translation function 310c is then stored in the translation function pool 130 for future use.

Identifying a key value translation function 310 may, according to embodiments, be handled autonomously by the computing device 110, or may be responsive to a database command received by the computing device 110. When performed in response to a database command, such a command be formatted according to the syntax “<INSTUCTION> RI <CHILD>(FK) ON <PARENT>(PK) USING <INDICATOR>.” In such an example, <INSTRUCTION> indicates whether a new relationship should be created or an existing relationship should be modified between datasets 210. RI indicates that the command relates to referential integrity between datasets 210. <CHILD> is an identifier that identifies the child dataset of the relationship (e.g., dataset 210b). FK identifies which field in the records 220 of the child 210 is the foreign key 250. PARENT is an identifier that identifies the parent dataset 210 of the relationship (e.g., dataset 210a). PK identifies which field in the records 220 of the parent 210 is the primary key 240. USING indicates that a key value translation function 310 should be used for maintaining referential integrity between the parent and child. <INDICATOR> is a key translation indicator that identifies the key value translation function.

According to one example, in response to receiving the database command “CREATE RI DOGS(ID_NUMBER) ON OWNERS (SSN) USING RANDOM,” the computing device 110 randomly selects key value translation function 310a from the translation function pool 130, and uses that key value translation function 310a to create a parent/child relationship between the “OWNERS” and “DOGS” datasets 210, using the “SSN” field in the “OWNERS” dataset as the primary key 240 and the “ID_NUMBER” field in the “DOGS” dataset as the foreign key 250. To ensure that referential integrity between the “OWNERS” and “DOGS” datasets 210 exists, the computing device 110 may also delete records from the “DOGS” dataset 210, and/or update the values of the “ID_NUMBER” field with null values (i.e., to ensure that no record 220 in the “DOGS” dataset 210 makes an invalid reference to the “OWNERS” dataset 210, according to the selected translation function 310a).

According to another example, in response to subsequently receiving the database command “UPDATE RI DOGS(ID_NUMBER) ON OWNERS(SSN) USING AUTOMATIC,” the computing device generates a new key value translation function 310 to replace the previous randomly-selected key value translation function 310. The new key translation function 310 is then stored in the translation function pool 130 as previously described. According to embodiments, such an update command further causes the computing device 110 to update all of the foreign key 250 values according to the new key value translation function 310 and the relationships already established between the datasets 210.

According to yet another example, in response to further subsequently receiving the database command “UPDATE RI DOGS(ID_NUMBER) ON OWNERS(SSN) USING (x+13=y),” the computing device uses x+13=y as a new key value translation function 310 to replace the previous automatically-generated key value translation function 310. The new key translation function 310 is then stored in the translation function pool 130 as previously described.

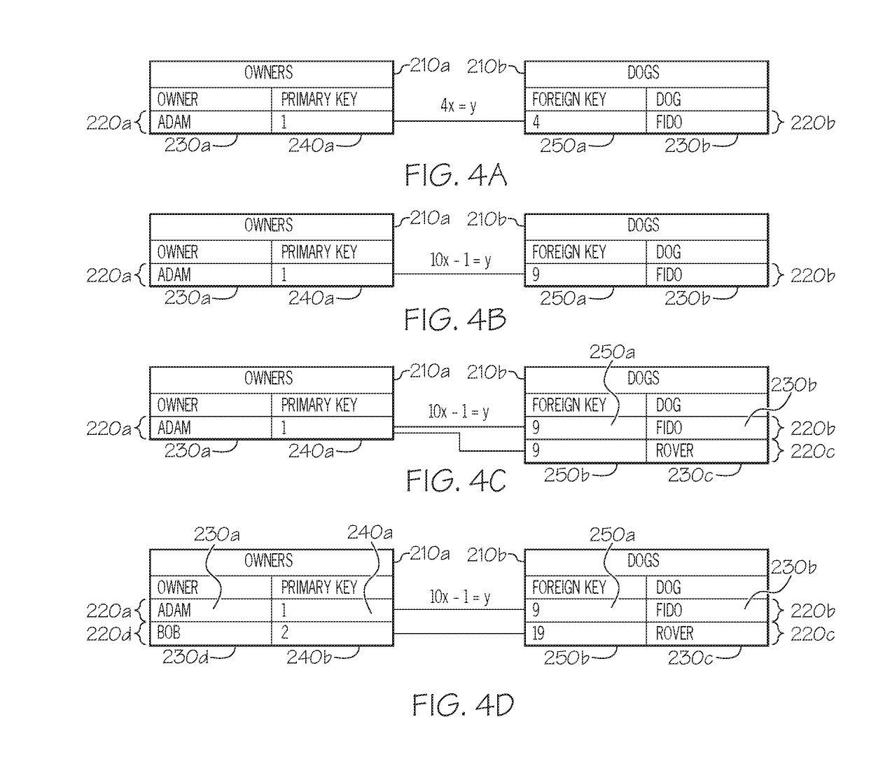

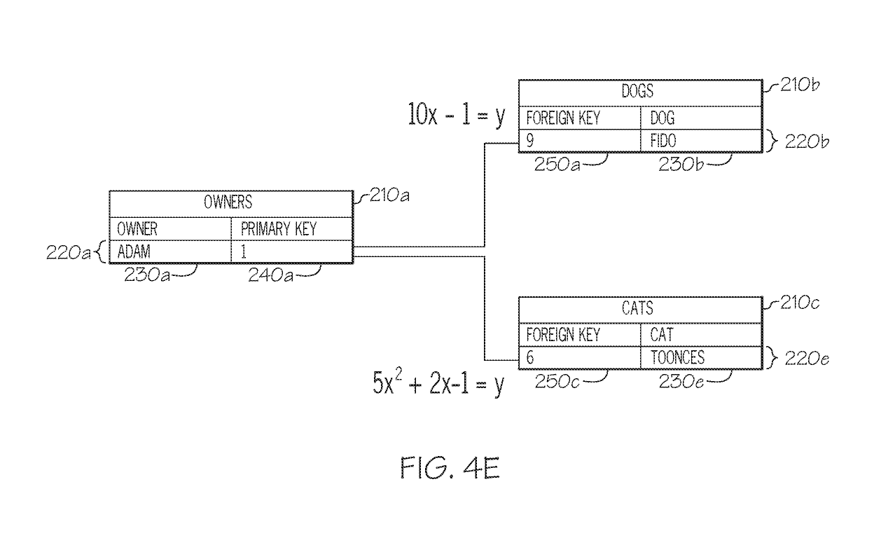

In view of the above, FIGS. 4A-E illustrate an example of maintaining referential integrity among datasets 210 in response to various database commands, according to embodiments of the present disclosure. In particular, the referential integrity illustrated in FIGS. 4A-4E is maintained using different primary key 240 and foreign key 250 values between related datasets 210. As will be shown below, even though the primary key 240 and foreign key 250 values are different between related datasets 210, invalid references are prevented by maintaining a consistent relationship between primary key 240 and foreign key 250 that is in accordance with a key value translation function 310.

To begin, FIG. 4A illustrates two datasets 210a, 210b, which the computing device 110 initially created in response to receiving a “CREATE” command with a key translation indicator that identified a user-specified key value translation function 310b of 4x=y. In response, the computing device 110 stored the key value translation function 310b in the translation function pool 130 as depicted in FIG. 3.

The “CREATE” command that caused the computing device 110 to create the datasets 210a, 210b comprised an identifier for the parent dataset 210a of “OWNERS” and an identifier for the child dataset 210b of “DOGS.” Initially, these two datasets 210a, 210b were empty. However, a user subsequently added “Adam” to the list of “OWNERS,” which the computing device 110 stored as record 220a in parent dataset 210a. To store the record 220a in parent dataset 210a, the computing device populated field 230a with the name “Adam,” and generated a unique value of “1” for the primary key 240a.

The user then added “Fido” to the list of “DOGS” with Adam as the owner. To do so, the computing device 110 stored “Fido” in the child dataset 210b as record 220b in association with Adam's record 220a in the parent dataset 210a. To store the record 220b in child dataset 210b, the computing device populated field 230b with the name “Fido” and generated a value of “4” for the foreign key 250a as specified by the received user-specified key value translation function 310b of 4x=y.

Having stored Adam's record 220a in dataset 210a and Fido's record 220b in dataset 210b, a user of the computing device 110, a user of the remote device 115, or both are able to issue one or more queries against the database 120 such that both of records 220a, 220b are located and selected. For example, a user may request all dogs owned by Adam. In response to such a query, the computing device 110 will search dataset 210a for record 220a corresponding to “Adam,” then apply the key value translation function 310b to the value of the primary key 240a to obtain the foreign key 250a of the record 220b corresponding to the dog owned by Adam, namely, Fido.

Similarly, a user may request Fido's owner. In response to such a query, the computing device 110 will search dataset 210b for record 220b corresponding to “Fido,” then apply the key value translation function 310b to the value of the foreign key 250a to obtain the primary key 240a of the record 220a corresponding to Fido's owner, namely Adam. Accordingly, the computing device 110 may select first and second records from first and second datasets, respectively, by applying the key value translation function to one of the primary key 240 or foreign key 250 values to determine the other of the key values.

After the datasets 210a, 210b are established as depicted in FIG. 4A, the computing device 110 receives an “UPDATE” command indicating that the computing device 110 should randomly select a new key value translation function 310. In response, the computing device 110 randomly selects the key value translation function 310a of 10x−1=y, which the computing device 110 then applies to record 220b by recalculating a value for foreign key 250a. In accordance with the randomly-selected key value translation function 310a, and as depicted in FIG. 4B, the new value established for the foreign key 250a is “9.”

After the datasets 210a, 210b are established as depicted in FIG. 4B, Adam buys a new dog named “Rover.” Accordingly, a user of the computing device 110 adds “Rover” to the list of “DOGS” with Adam as the owner, resulting in the dataset 210b to be updated as shown in FIG. 4C. To add the new dog, the computing device 110 stores “Rover” in the child dataset 210b as record 220c in association with Adam's record 220a in the parent dataset 210a. To store the record 220c in child dataset 210b, the computing device populates field 230c with the name “Rover” and generates a value of “9” for the foreign key 250a in accordance with the randomly-selected key value translation function 310a. Thus, the key value translation function 310a, as applied to primary key 240a, results in the same value to be calculated for the foreign keys 250a, 250b of both records 220b, 220c, which reflects the relationship of both of those records 220b, 220c with record 220a.

After the datasets 210a, 210b are established as depicted in FIG. 4C, Adam gives Rover to a new owner, Bob. Accordingly, a user of the computing device 110 adds “Bob” to the list of “OWNERS,” which results in the datasets 210a, 210b being updated as depicted in FIG. 4D. In particular, to add “Bob” to the list of “OWNERS,” the computing device 110 stores record 220d in parent dataset 210a, populating field 230d with the name “Bob,” and generating a unique value of “2” for the primary key 240b. To reflect Bob's new relationship with Rover, the computing device 110 calculates a new value of “19” for the foreign key 250b of record 220c in accordance with the key value translation function 310a.

After the datasets 210a, 210b are established as depicted in FIG. 4D, Rover dies and Adam decides to get a cat named “Toonces.” FIG. 4E illustrates the datasets 210a, 210b as modified to reflect these occurrences. In particular, to reflect Rover's death, a user of the computing device 110 sends a database query to the computing device 110 to determine Rover's owner. The database query finds Rover's record 220c in the “DOGS” dataset 210b, then applies the key value translation function 310a to the value of the corresponding foreign key 250b, i.e., “19.” The result of applying the key value translation function 310a to value of foreign key 250b is the value “2,” which uniquely identifies Bob's record 220d by its primary key 240b. The computing device 110 then deletes Rover's record 220c (since that dog has died). Also, since Bob owns no other dogs (i.e., no other dogs have a foreign key 250 value of “19”), the computing device 110 also deletes Bob's record 220d.

To reflect Adam getting a cat, a user of the computing device 110 issues a command to create a new relationship between the existing “OWNERS” list as the parent dataset 210a and a new “CATS” list as the child dataset 210c. The command indicates that the computing device 110 should automatically generate a new key value translation function 310. In response, the computing device 110 generates the key value translation function 310c of 5x²+2x−1=y, which is then stored in the translation function pool 130 as described above. The computing device 110 also creates the child dataset 210c. A user then adds “Toonces” to the “CATS” dataset 210c, indicating that Adam should be the owner. In response, the computing device 110 stores record 220e in dataset 210c, populating field 230e with the name “Toonces” and generating a value of “6” for the foreign key 250c in accordance with the automatically-generated key value translation function 310c given Adam's primary key 240a value of “1.”

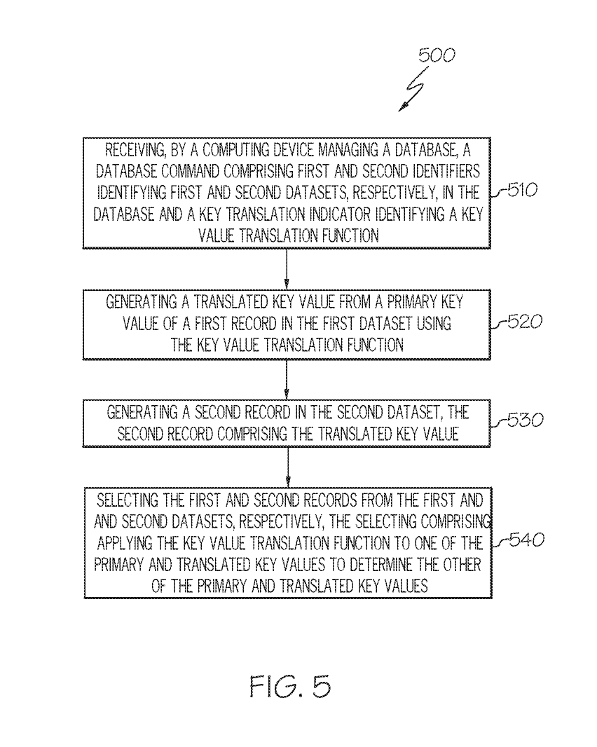

In view of all of the above, an example of a computer-implemented method 500 according to embodiments of the present disclosure is illustrated in FIG. 5. The method 500 comprises receiving, by a computing device 110 managing a database 120, a database command comprising first and second identifiers and a key translation indicator (block 510). The first and second identifiers identify first and second datasets 210a, 210b respectively, in the database 120. The key translation indicator identifies a key value translation function 310.

The method 500 further comprises, responsive to receiving the database command, generating a translated key 250a value from a primary key 240a value of a first record 220a in the first dataset 210a using the key value translation function 310 (block 520), and generating a second record 220b in the second dataset 210b, the second record 220b comprising the translated key value 250a (block 530). The method 500 further comprises, also in response to receiving the database command, selecting the first and second records 220a, 220b from the first and second datasets, 210a, 210b respectively (block 540). The selecting comprises applying the key value translation function 310 to one of the primary or translated key 240a, 250a value to determine the other of the primary or translated key 240a, 250a value.

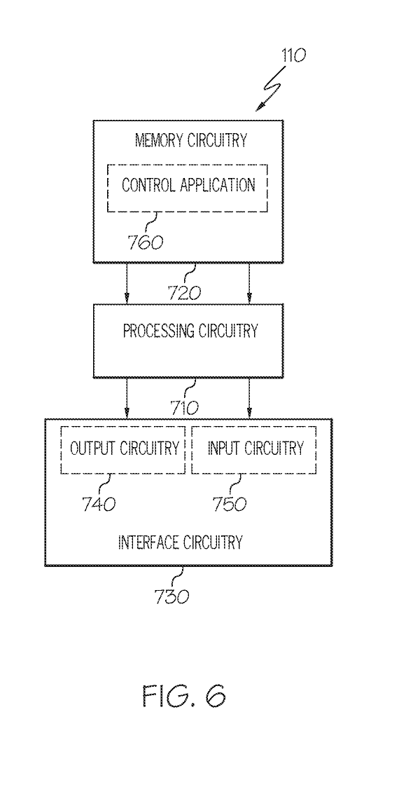

Other embodiments of the present disclosure include the computing device 110 implemented according to the hardware illustrated in FIG. 6. The example hardware of FIG. 6 comprises processing circuitry 710, memory circuitry 720, and interface circuitry 730. The processing circuitry 710 is communicatively coupled to the memory circuitry 720 and the interface circuitry 730, e.g., via one or more buses. The processing circuitry 710 may comprise one or more microprocessors, microcontrollers, hardware circuits, discrete logic circuits, hardware registers, digital signal processors (DSPs), field-programmable gate arrays (FPGAs), application-specific integrated circuits (ASICs), or a combination thereof. For example, the processing circuitry 710 may be programmable hardware capable of executing software instructions stored as a machine-readable computer program 760 in the memory circuitry 720. The memory circuitry 720 of the various embodiments may comprise any non-transitory machine-readable media known in the art or that may be developed, whether volatile or non-volatile, including but not limited to solid state media (e.g., SRAM, DRAM, DDRAM, ROM, PROM, EPROM, flash memory, solid state drive, etc.), removable storage devices (e.g., Secure Digital (SD) card, miniSD card, microSD card, memory stick, thumb-drive, USB flash drive, ROM cartridge, Universal Media Disc), fixed drive (e.g., magnetic hard disk drive), or the like, wholly or in any combination.

The interface circuitry 730 may be a controller hub configured to control the input and output (I/O) data paths of the computing device 110. Such I/O data paths may include data paths for exchanging signals over a communications network 105 and data paths for exchanging signals with a user. For example, the interface circuitry 730 may comprise a transceiver configured to send and receive communication signals over one or more of a cellular network, Ethernet network, or optical network. The interface circuitry 730 may also comprise one or more of a graphics adapter, display port, video bus, touchscreen, graphical processing unit (GPU), display port, Liquid Crystal Display (LCD), and Light Emitting Diode (LED) display, for presenting visual information to a user. The interface circuitry 730 may also comprise one or more of a pointing device (e.g., a mouse, stylus, touchpad, trackball, pointing stick, joystick), touchscreen, microphone for speech input, optical sensor for optical recognition of gestures, and keyboard for text entry.

The interface circuitry 730 may be implemented as a unitary physical component, or as a plurality of physical components that are contiguously or separately arranged, any of which may be communicatively coupled to any other, or may communicate with any other via the processing circuitry 710. For example, the interface circuitry 730 may comprise output circuitry 740 (e.g., transmitter circuitry configured to send communication signals over the communications network 105) and input circuitry 750 (e.g., receiver circuitry configured to receive communication signals over the communications network 105). Similarly, the output circuitry 740 may comprise a display, whereas the input circuitry 750 may comprise a keyboard. Other examples, permutations, and arrangements of the above and their equivalents will be readily apparent to those of ordinary skill.

According to embodiments of the hardware illustrated in FIG. 6, the interface circuitry 730 is configured to exchange signals with a database 120 managed by the computing device 110, and a user interface. The processing circuitry 710 is configured to identify first and second datasets 210a, 210b of the database 120 by first and second identifiers, respectively, and generate a second record 220b in the second dataset 210b via the interface circuitry 730. The second record 220b comprises a translated key 250a value generated from a primary key 240a value of a first record 220a in the first dataset 210a according to a key value translation function 310. The processing circuitry 710 is further configured to select the first and second records 220a, 220b from the first and second datasets 210a, 210b, respectively. To select the first and second records 220a, 220b the processing circuitry 710 is configured to apply the key value translation function 310 to one of the primary or translated key 240a, 250a value to determine the other of the primary or translated key value 240a, 250a.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A computer-implemented method comprising:
receiving, by a computing device managing a database, a database command comprising:
first and second identifiers identifying first and second datasets, respectively, in the database; and
a key translation indicator identifying a key value translation function;
responsive to receiving the database command:
generating a translated key value from a primary key value of a first record in the first dataset using the key value translation function; and
generating a second record in the second dataset, the second record comprising the translated key value; and
selecting the first and second records from the first and second datasets, respectively, the selecting comprising applying the key value translation function to one of the primary or translated key value to determine the other of the primary or translated key value.

2. The computer-implemented method of claim 1, wherein the key translation indicator comprises the key value translation function and is specified by a user.

3. The computer-implemented method of claim 2, further comprising storing the key value translation function in memory circuitry.

4. The computer-implemented method of claim 1, further comprising selecting the key value translation function, from a pool of predefined key value translation functions stored in memory circuitry, based on the key translation indicator.

5. The computer-implemented method of claim 4, wherein selecting the key translation function comprises randomly selecting the key translation function, from the pool of predefined key translation functions, based on the key translation indicator.

6. The computer-implemented method of claim 1, further comprising generating the key translation function based on the key translation indicator.

7. The computer-implemented method of claim 1, wherein selecting the first and second records from the first and second datasets, respectively, is responsive to receiving a database query identifying one of the first or second record.

8. The computer-implemented method of claim 1, further comprising:
generating a third record in the second dataset, the third record comprising the translated key value; and
selecting the third record from the second dataset in addition to the selecting of the first and second records.

9. The computer-implemented method of claim 1, further comprising:
generating an additional translated key value from the primary key value of the first record using an additional key value translation function;
generating a fourth record in a third dataset of the database, the fourth record comprising the additional translated key value; and
selecting the fourth record from the third dataset in addition to the selecting of the first and second records, the selecting of the fourth record comprising applying the additional key value translation function to one of the primary or additional translated key value to determine the other of the primary or additional translated key value;
wherein the key value translation function is different from the additional key value translation function, and the translated key value is different from the additional translated key value.

10. The computer-implemented method of claim 1, wherein the key value translation function comprises an encryption function, and wherein generating the translated key value from the primary key value comprises encrypting the primary key value using the encryption function.

11. A computing device comprising:
interface circuitry configured to exchange signals with:
a database managed by the computing device; and
a user interface; and
processing circuitry communicatively coupled to the interface circuitry and configured to:
identify first and second datasets of the database by first and second identifiers, respectively;
generate a second record in the second dataset via the interface circuitry, the second record comprising a translated key value generated from a primary key value of a first record in the first dataset according to a key value translation function; and
select the first and second records from the first and second datasets, respectively, wherein to select the first and second records the processing circuitry is configured to apply the key value translation function to one of the primary or translated key value to determine the other of the primary or translated key value.

12. The computing device of claim 11, wherein the processing circuitry is further configured to receive, via the interface circuitry, a database command comprising a user-specified key translation indicator that comprises the key value translation function.

13. The computing device of claim 12, wherein the processing circuitry is further configured to store the key value translation function via the interface circuitry.

14. The computing device of claim 11, wherein the processing circuitry is further configured to:
receive, via the interface circuitry, a database command comprising a key translation indicator;
select the key value translation function, from a pool of predefined key value translation functions, accessed via the interface circuitry, based on the key translation indicator.

15. The computing device of claim 14, wherein to select the key translation function, the processing circuitry is configured to randomly select the key translation function, from the pool of predefined key translation functions, based on the key translation indicator.

16. The computing device of claim 11, wherein the processing circuitry is further configured to:
receive, via the interface circuitry, a database command comprising a key translation indicator; and
generate the key translation function based on the key translation indicator.

17. The computing device of claim 11, wherein the processing circuitry is configured to select the first and second records from the first and second datasets responsive to receiving, via the interface circuitry, a database query identifying one of the first or second record.

18. The computing device of claim 11, wherein the processing circuitry is further configured to:
generate a third record in the second dataset via the interface circuitry, the third record comprising the translated key value;
select the third record from the second dataset in addition to the selecting of the first and second records.

19. The computing device of claim 11, wherein the processing circuitry is further configured to:
generate an additional translated key value from the primary key value of the first record using an additional key value translation function;
generate a fourth record in a third dataset of the database, the fourth record comprising the additional translated key value; and
select the fourth record from the third dataset in addition to the selecting of the first and second records, the further selecting of the fourth record comprising applying the additional key value translation function to one of the primary or additional translated key value to determine the other of the primary or additional translated key value;
wherein the key value translation function is different from the additional key value translation function, and the translated key value is different from the additional translated key value.

20. The computing device of claim 11, wherein the key value translation function comprises an encryption function, and wherein to generate the translated key value from the primary key value, the processing circuitry is configured to encrypt the primary key value using the encryption function.

21. A non-transitory computer readable medium storing a computer program product for controlling a programmable computing device managing a database, the computer program product comprising software instructions that are executable to cause the programmable computing device to:
receive a database command comprising:
first and second identifiers identifying first and second datasets, respectively, in the database; and
a key translation indicator identifying a key value translation function;
responsive to receiving the database command:
generate a translated key value from a primary key value of a first record in the first dataset using the key value translation function; and
generate a second record in the second dataset, the second record comprising the translated key value; and
select the first and second records from the first and second datasets, respectively, the selecting comprising applying the key value translation function to one of the primary or translated key value to determine the other of the primary or translated key value.
